(19) United States
(12) Patent Application Publication
(10) Pub. No.: US 2007/0198764 A1
(43) Pub. Date: Aug. 23, 2007

(54) Semiconductor arrangement and method for operating a semiconductor arrangement

(76) Inventor: Gerhard Risse, Muenchen (DE)

Correspondence Address: SLATER & MATSIL LLP, 17950 PRESTON ROAD, SUITE 1000, DALLAS, TX, 75252, US

(21) Appl. No.: 11/706,857

(22) Filed: Feb. 13, 2007

(30) Foreign Application Priority Data
Feb. 13, 2006 (DE) 10 2006 006 571.9

(51) Int. Cl. G06F 12/00

(52) U.S. Cl. 711/100

(57) ABSTRACT

A semiconductor arrangement includes a first control unit, a second control unit and at least one memory module. Between the first control unit and the at least one memory module and between the second control unit and the at least one memory module, data can be transferred both in a first direction and in a second direction. The at least one memory module includes a first input interface for receiving data from a first direction, a first output interface for transmitting data in a second direction, a second input interface for receiving data from the second direction, and a second output interface for transmitting data in the first direction. In order to transmit and receive data in the first and second direction, respectively, in each case first and second input interfaces and in each case first and second output interfaces are provided in the case of the first and in the case of the second control unit. The second output interface of the first control unit is coupled to the second input interface of the second control unit, and the second output interface of the second control unit is coupled to the second input interface of the first control unit.

This application claims priority to German Patent Application 10 2006 006 571.9, which was filed Feb. 13, 2006, and is incorporated herein by reference.

### TECHNICAL FIELD

The present invention relates to a semiconductor arrangement and to a method for operating a semiconductor arrangement. The invention relates in particular to semiconductor arrangements comprising a plurality of control units and a multiplicity of memory modules.

### BACKGROUND

For data storage, computer systems usually have a memory controller and memory devices such as, for instance, read/write memories or random access memories (RAM memories) which are embodied for example as FB-DIMM (Fully Buffered Dual Inline Memory Module). Each of the FB-DIMMs comprises a memory component for storing data, a memory interface and an advanced memory buffer (AMB). The AMB serves to control the data interchange between the memory controller and the memory component. AMB receives write or command data in serial form from the memory controller, converts said data into parallel data streams and forwards them via the memory interface to the memory component. In addition, the AMB can convert data stored in the memory components into serial data packets. Moreover, the AMB has a pass-through logic, by means of which data packets intended for another FB-DIMM are forwarded.

Computer systems typically have a plurality of the FB-DIMMs. The memory controller transmits a first type of data frames with write or command data in a first direction to the memory modules via a 10 bit wide data line. The memory controller receives a second type of data frames with response or read data from the memory modules via a 12 to 14 bit wide data line.

For data transfer in the first direction, the memory controller has an output interface. The memory modules have suitable first input interfaces for receiving the first type of data frames from the first direction, and suitable first output interfaces for transferring the first type of data frames to the memory module that is adjacent in the first direction, respective first output interfaces of the memory modules being coupled to respective first input interfaces of memory modules that are adjacent in the first direction. Consequently, data frames of the first type can be transferred in the first direction from one memory module to the next.

For data transfer in the second direction, the memory modules have suitable second output interfaces for transferring the second type of data frames to the memory module that is adjacent in the second direction, and suitable second input interfaces for receiving the second type of data frames, respective second output interfaces of the memory modules being coupled to respective second input interfaces of memory modules that are adjacent in the second direction.

In the event of an interruption of the connection, for example due to a defective AMB of one of the memory modules, the data transfer between the memory controller and the memory modules which are situated in the first direction with respect to the interruption is disturbed.

Memory modules which are arranged far away with respect to the memory controller have a high latency. In the case of n memory modules, the n-th memory module, for example, has a latency of n point-to-point connections.

Since the memory device only has one interface between the memory controller and the memory modules, moreover, the bandwidth for the data transfer is limited.

In the case of a memory device comprising n memory modules, data frames which are transferred in the first direction and are intended for the first memory module are transferred through the entire series arrangement. Consequently, n high-speed connections are active. This leads to a high power consumption of the semiconductor arrangement.

The memory device can only be driven by a memory controller. Therefore in computer systems with a plurality of central control units (CPUs), the communication between the individual central control units and the memory modules must be effected either via a common external memory controller or, in the case of memory controllers integrated in the central control units, by a direct communication between the individual control units in order to read data from the memory modules or to write data to the memory modules.

### SUMMARY OF THE INVENTION

In one aspect, the present invention provides a semiconductor arrangement and also a method for operating a semiconductor arrangement in which the problems described above are avoided and the reliability of the semiconductor arrangement is increased.

A semiconductor arrangement according to one embodiment comprises at least one memory module comprising at least one memory component for storing data, a first input interface for receiving data from a first direction, a first output interface for transmitting data in a second direction, a second input interface for receiving data from the second direction, and a second output interface for transmitting data in the first direction. The semiconductor arrangement furthermore comprises a first control unit comprising a control circuit, a first input interface, a second input interface, a first output interface and a second output interface. The control circuit of the first control unit is coupled to the first input interface of the first control unit in order to receive data from the at least one memory module from the second direction. The control circuit of the first control unit is coupled to the second input interface of the first control unit in order to receive data from the first direction. The control circuit of the first control unit is coupled to the first output interface of the first control unit in order to transmit data to the at least one memory module in the first direction. The control circuit of the first control unit is coupled to the second output interface of the first control unit in order to transmit data in the second direction.

The semiconductor arrangement furthermore comprises at least one second control unit comprising a control circuit, a first input interface, a second input interface, a first output interface and a second output interface. The control circuit of the second control unit is coupled to the first input interface of the second control unit in order to receive data from the at least one memory module from the first direction. The control circuit of the second control unit is coupled to the second input interface of the second control unit in order to receive data from the second direction. The control circuit of the second control unit is coupled to the first output interface in order to transmit data to the at least one memory module in the second direction. The control circuit of the second control unit is coupled to the second output interface of the second control unit in order to transmit data in the first direction.

The second output interface of the first control unit is coupled to the second input interface of the second control unit and the second output interface of the at least one second control unit is coupled to the second input interface of the first control unit.

Another embodiment provides a method for operating a semiconductor arrangement. The semiconductor arrangement comprises at least one memory module comprising a memory component for storing data, a first control unit comprising a control circuit and a second control unit comprising a control circuit. The method comprises transmission of data in a first direction from the control circuit of the first control unit to the at least one memory module and reception of data in the control circuit of the first control unit from the at least one memory module from a second direction. The method furthermore comprises transmission of data in the second direction from the control circuit of the second control unit to the at least one memory module and reception of data in the control circuit of the second control unit from the at least one memory module from the first direction.

### BRIEF DESCRIPTION OF THE DRAWINGS

Exemplary embodiments are illustrated schematically in the figures, where:

FIG. 1 shows a schematic illustration of a semiconductor arrangement in accordance with one embodiment of the invention;

FIG. 2 shows a schematic illustration of a development of the semiconductor arrangement illustrated in FIG. 1;

FIG. 3 and FIG. 4 schematically show a read operation of a first type in the case of the semiconductor arrangement illustrated in FIG. 1;

FIG. 5 and FIG. 6 schematically show a read operation of a second type in the case of the semiconductor arrangement illustrated in FIG. 1;

FIG. 7 and FIG. 8 schematically show a write operation in the case of the semiconductor arrangement illustrated in FIG. 1; and

FIG. 9 illustrates the procedure when removing or replacing one of the memory modules (100a, 100b, 100c, 100d).

### DETAILED DESCRIPTION OF ILLUSTRATIVE EMBODIMENTS

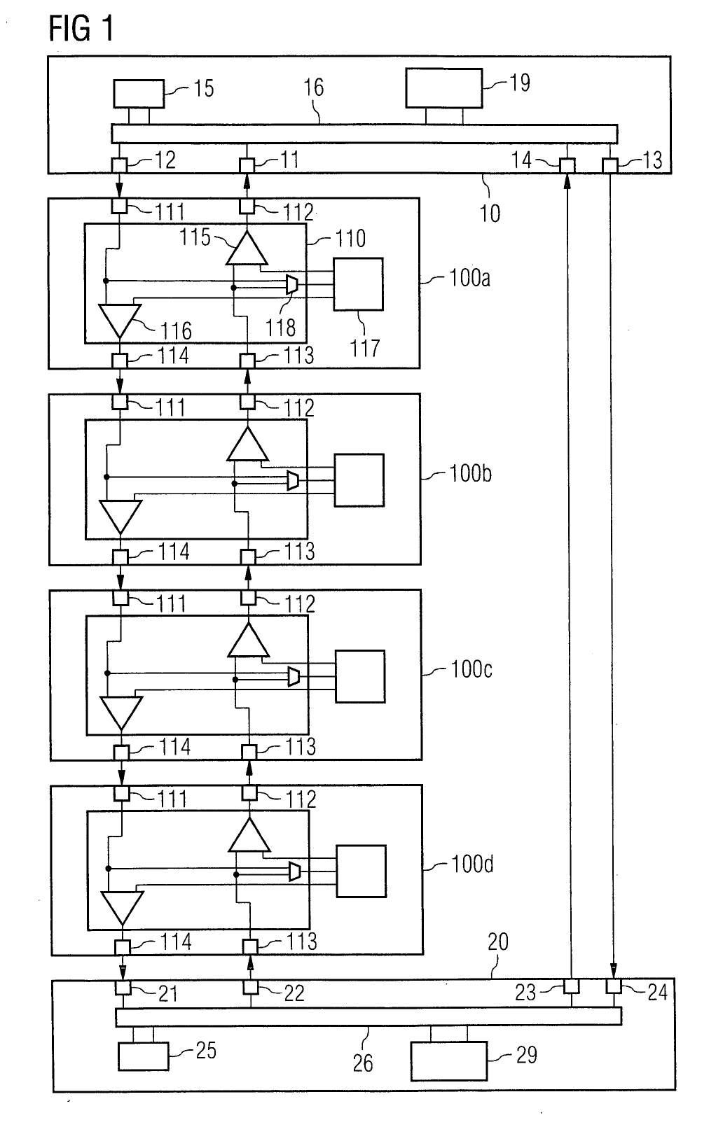

FIG. 1 shows a schematic illustration of a semiconductor arrangement in accordance with one embodiment of the invention. The semiconductor arrangement comprises a first control unit 10, second control unit 20 and also a multiplicity of memory modules 100a, 100b, 100c and 100d which are arranged in a chain. The first control unit 10 and the second control unit 20 are in each case arranged at remote ends of the chain of memory modules 100a, 100b, 100c and 100d. The memory modules 100a, 100b, 100c and 100d are embodied identically.

A first direction as used herein relates to a direction along a ring-shaped conductive path proceeding from the first control unit 10 towards a first one 100a of the memory modules, coupling the memory modules in series, proceeding from a last one 100d of the memory modules towards the second control unit 20 and proceeding from the second control unit 20 to the first control unit 10.

A second direction as used herein relates to a direction along a ring-shaped conductive path proceeding from the first control unit 10 towards the second control unit 20, proceeding from the second control unit 20 towards the last one 100d of the memory modules, coupling the memory modules serially and proceeding from the first one 100a of the memory modules towards the first control unit 10.

The construction of the memory modules 100a, 100b, 100c and 100d will now be explained on the basis of memory module 100a. The memory module 100a comprises a memory component 117 for storing data. The memory component 117 is preferably a dynamic random access memory component (DRAM) in which data can be repeatedly stored and read out. By way of example, the memory component 117 has the functionality of a memory component of the double data rate type (DDR type) or of a similar memory component type.

The memory module 100a furthermore has an interface block 110 with a first input interface 111, a first output interface 112, a second input interface 113 and a second output interface 114. The input and output interfaces can transfer data such as, read data, write data, but also command data.

Via the first input interface 111, the memory module 100a can receive data from the first direction. Via the first output interface 112, the memory module 100a can transmit data in the second direction. Via the second input interface 1113, the memory module 100a can receive data from the second direction. Via the second output interface 114, the memory module 110a can transmit data in the first direction.

The memory module 100a is configured, upon reception of a corresponding control command, either to deactivate the first input interface 111 and the first output interface 112 or to deactivate the second input interface 113 and the second output interface 114.

The first 112 and the second 114 output interface furthermore in each case comprise an output driver 115, 116, which outputs the data in a frame-based format. In this case, the read and write data or command data are output in the same frame format. The first output interface 112 and the second output interface 114 are embodied for the transfer of data with an identical data width. The first input interface 111 and the second input interface 113 are embodied for the transfer of data with the same data width. Preferably, the first input interface 111, the second input interface 113, the first output interface 112 and the second output interface 114 are embodied for the transfer of data with the same data width.

Via an interface 118, a data input of the memory component 117 is connected both to the first input interface 111 and to the second input interface 113 of the memory module 100a. By means of the interface 118, write or command data can be transferred from the first input interface 111 or write or command data can be transferred from the second input interface 113 to the memory component 117.

Data frames which are received by the memory module 100a via the first input interface 111 and were transmitted from the first control unit 10 or from a memory module that is adjacent in the second direction are transferred via an electrically conductive connection arranged between the first input interface 111 and the second output interface 114 and the output interface 114 to the second control circuit 20 or to a memory module that is adjacent in the first direction.

Data frames which are received by the memory module 100a via the second input interface 113 and were transmitted from the second control unit 20 or from a memory module that is adjacent in the first direction are transferred via an electrically conductive connection arranged between the second input interface 113 and the first output interface 112 and the first output interface 112 to the first control unit 10 or to a memory module that is adjacent in the second direction.

In a manner dependent on data stored in the memory component 117, the output drivers 115, 116 insert read data into the data frames and transmit the data frames in the first and respectively second direction.

The first control unit 10 comprises a microprocessor 19, a control circuit 15, a switch 16, a first input interface 11, a second input interface 14, a first output interface 12 and a second output interface 13.

The microprocessor 19 is coupled via the switch 16 to the control circuit 15 for the interchange of data. Furthermore, the microprocessor 19 is coupled via the switch 16 to the first output interface 12, the first input interface 11, the second output interface 13 and the second input interface 14 for the transfer of data.

A control circuit 15 is coupled to the first input interface 11 in order to receive data from the memory modules 100a, 100b, 100c and 100d from the second direction. The control circuit 15 is coupled to the second input interface 14 in order to receive data from the first direction. The control circuit 15 is coupled to the first output interface 12 in order to transmit data to the memory modules 100a, 100b, 100c and 100d in the first direction. The control circuit 15 is coupled to the second output interface 13 in order to transmit data in the second direction.

The first input interface 11 of the first control unit 10 is coupled to the second output interface 13 of the first control unit 10 in order to transfer data in the second direction. The second input interface 14 of the first control unit 10 is coupled to the first output interface 12 of the first control unit 10 in order to transfer data in the first direction.

The coupling of the control circuit 15 to the first input interface 11, the second input interface 14, the first output interface 12 and the second output interface 13 is effected via the switch 16.

The second control unit 20 comprises a microprocessor 29, a control circuit 25, a switch 26, a first input interface 21, a second input interface 24, a first output interface 22 and a second output interface 23.

The microprocessor 29 is coupled via the switch 26 to the control circuit 25 for the interchange of data. The microprocessor 29 is additionally coupled via the switch 26 to the first output interface 22, the first input interface 21, the second output interface 23 and the second input interface 24 for the transfer of data.

The control circuit 25 is coupled to the first input interface 21 in order to receive data from the memory modules 100a, 100b, 100c and 100d from the first direction. The control circuit 25 is coupled to the second input interface 24 in order to receive data from the second direction. The control circuit 25 is coupled to the first output interface 22 in order to transmit data to the memory modules 100a, 100b, 100c and 100d in the second direction. The control circuit 25 is coupled to the second output interface 23 in order to transmit data in the first direction.

The first input interface 21 of the second control unit 20 is coupled to the second output interface 23 of the second control unit 20 in order to transfer data in the first direction. The second input interface 24 of the second control unit 20 is coupled to the first output interface 22 of the second control unit 20 in order to transfer data in the second direction.

The coupling of the control circuit 25 to the first input interface 21, the second input interface 24, the first output interface 22 and the second output interface 23 is effected via the switch 26.

The second output interface 13 of the first control unit 10 is coupled to the second input interface 24 of the second control unit 20. Via this coupling, data can be transferred from the first control unit 10 to the second control unit 20. By way of example, data can be transferred from the microprocessor 19 of the first control unit 10 to the microprocessor 29 of the second control unit.

The second output interface 23 of the second control unit 20 is coupled to the second input interface 14 of the first control unit 10. Via this coupling, data can be transferred from the second control unit 20 to the first control unit.

The first output interface 12 of the first control unit 10 is coupled to the first input interface 111 of the first memory module 100a of the memory modules in order to transfer data in the first direction. The first output interface 112 of the first memory module 100a is coupled to the first input interface 11 of the first control unit 10 in order to transfer data in the second direction. The memory module 100d forms the last memory module of the chain of memory modules 100a, 100b, 100c and 100d. The first output interface 22 of the second control unit 20 is coupled to the second input interface 113 of the last memory module 100d in order to transfer data in the second direction. The second output interface 114 of the last memory module 100d is coupled to the first input interface 21 of the second control unit 20 in order to transfer data in the first direction. In the remaining memory modules 100b, 100c, the respective first input interface 111 is coupled to the respective second output interface 114 of a respective memory module 110a, 100b that is adjacent in the second direction, in order to transfer data in the first direction. The respective first output interface 112 of each of the remaining memory modules 100b, 100c is coupled to the respective second input interface 113 of the respective memory module 100a, 100b that is adjacent in the second direction, in order to transfer data in the second direction. The respective second input interface 113 of each of the remaining memory modules 100b, 100c is coupled to the respective first output interface 112 of a respective memory module 100c, 100d that is adjacent in the first direction, in order to transfer data in the second direction, and the respective second output interface 114 of each of the remaining memory modules 100b, 100c is coupled to the respective first input interface 111 of the respective memory module 100c, 100d that is adjacent in the first direction, in order to transfer data in the first direction.

One memory module of the multiplicity of memory modules 100a, 100b, 100c and 100d may be embodied as a redundant memory module, in the memory component 117 on which data are stored in a manner dependent on data stored in the memory components 117 of the remaining memory modules. Consequently, in the event of a functional disturbance of one of the memory modules, the data of the memory module with the functional disturbance can be recovered by the read-out of each individual one of the multiplicity of memory modules.

In the case of the semiconductor arrangement according to an embodiment shown in FIG. 1, data can be transferred both in the first direction and in the second direction between the first control unit and each of the memory modules. Moreover, data can be transferred both in the first direction and in the second direction between the second control unit and each of the memory modules.

In the case of the semiconductor arrangement according to an embodiment shown in FIG. 1, both the first control unit 10 and the second control unit 20 have direct access to each memory module of the multiplicity of memory modules 100a, 100b, 100c, 100d via the respective first output interfaces 12, 22 and the respective first input interfaces 11, 21.

Moreover, for the first control unit 10 and for the second control unit 20 there is the possibility of indirectly accessing each memory module of the multiplicity of memory modules 100a, 100b, 100c, 100d via the respective second output interfaces 13, 23 and the respective second input interfaces 14, 24. In this case, a control unit accesses the memory modules by means of a data transfer via the respective other one of the control units. In the event of an interruption of the direct connection between the first control unit 10 or the second control unit 20 and one of the memory modules 100a, 100b, 100c, 100d, the first control unit 10 or the second control unit 20 can access said one memory module 100a, 100b, 100c, 100d via the indirect connection.

In contrast to a semiconductor arrangement comprising only one control unit, in the case of the semiconductor arrangement according to FIG. 1 provision is made merely of one further connection, namely the connection between the second control unit and the memory module connected thereto. At the same time, however, the data width of the data transfer is doubled by the semiconductor arrangement according to embodiments of the invention. Consequently, the power consumption per bandwidth is significantly reduced in the case of a semiconductor arrangement comprising more than one memory module.

Read or write accesses to the memory modules are coordinated by a direct communication between the first control unit 10 and the second control unit 20 via the respective second output interfaces 13, 23 and the respective second input interfaces 14, 24. By way of example, the first control unit may have access rights to a first subset of the multiplicity of memory modules, and the second control unit 20 may have access rights to a second subset of the multiplicity of memory modules, the second subset differing from the first subset.

In the case of the semiconductor arrangement according to FIG. 1, two control units share a multiplicity of memory modules. A memory controller is arranged at both ends of the chain comprising a multiplicity of memory modules. The access authorization for the transfer of read and write data or command data to the individual memory modules is regulated by means of a direct communication between the two control units. Both control units may have a direct read access to the multiplicity of memory modules, with the result that the volume of data which is interchanged between the two control units can be reduced since the data can be read directly from the individual memory modules of a multiplicity of memory modules instead of firstly being read by one control unit and then being transferred via a connection between the control units. As a result, the latency is significantly reduced.

Furthermore, the semiconductor arrangement according to FIG. 1 has the advantage that it provides a redundant coupling of the control units. In the event of a functional disturbance of the direct connection between the individual control units, a communication between the individual control units can be effected via the connection via the multiplicity of memory modules.

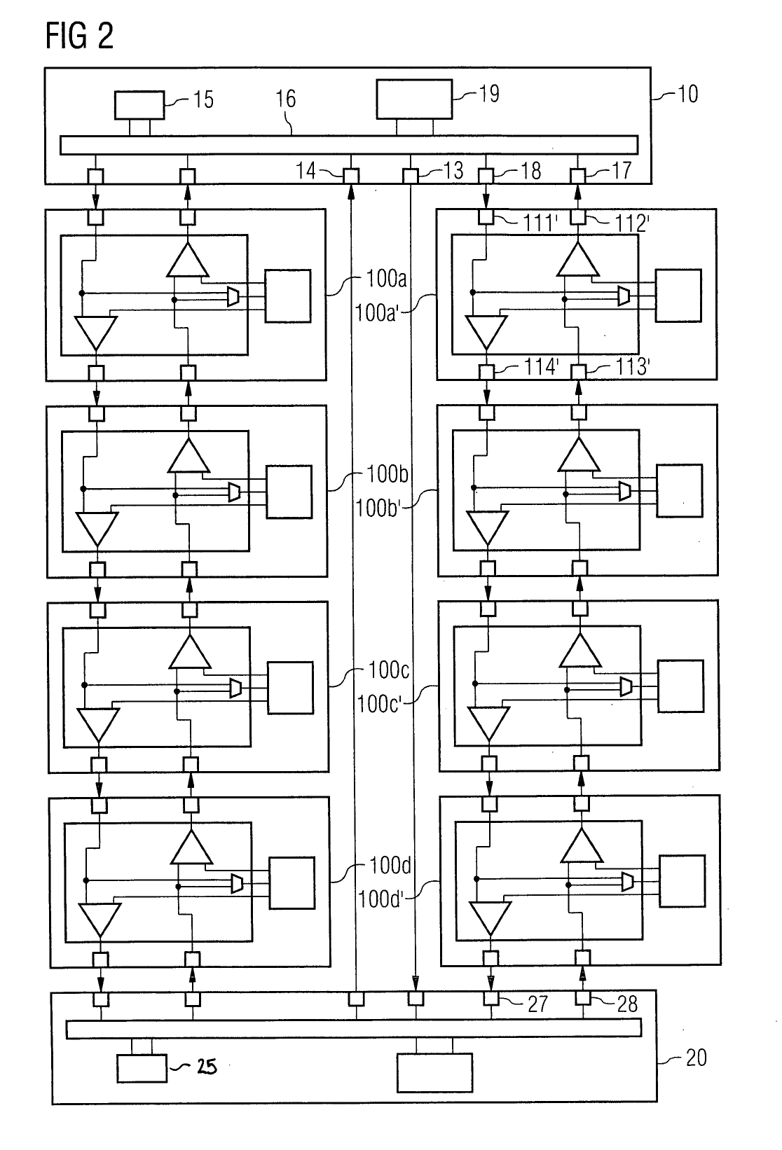

FIG. 2 shows a development of the semiconductor arrangement illustrated in FIG. 1. In addition to the semiconductor arrangement illustrated in FIG. 1, the semiconductor arrangement illustrated in FIG. 2 has a further multiplicity of memory modules 100a′, 100b′, 100c′, 100d′, each memory module of the further multiplicity of memory modules 100a′, 100b′, 100c′, 100d′ being embodied identically to the memory modules 100a, 100b, 100c, 100d. Moreover, the first control unit 10 and the second control unit 20 in each case have a third input interface 17, 27 and a third output interface 18, 28.

The control circuit 15 of the first control unit 10 is coupled to the third input interface 17 of the first control unit in order to receive data from one of the memory modules 100a′, 100b′, 100c′, 100d′from the second direction. The control circuit 15 of the first control unit 10 is coupled to the third output interface 18 in order to transmit data to one of the memory modules 100a′, 100b′, 100c′, 100d′ in the first direction. The control circuit 25 of the second control unit 20 is coupled to the third input interface 27 of the second control unit 20 in order to receive data from one of the memory modules 100a′, 100b′, 100c′, 100d′ from the first direction. The control circuit 25 of the second control unit 20 is furthermore coupled to the third output interface 28 in order to transmit data to one of the memory modules 100a′, 100b′, 100c′, 100d′ in the second direction.

The third output interface 18 of the first control unit 10 is coupled to the first input interface 111′ of the first memory module 100a′ of the further multiplicity of memory modules 100a′, 100b′, 100c′, 100d′ in order to transfer data in the first direction, the first output interface 112′ of the first memory module 100a′ of the further multiplicity of memory modules 100a′, 100b′, 100c′, 100d′ is coupled to the third input interface 17 of the first control unit 10 in order to transfer data in the second direction, the third output interface 28 of the second control unit 20 is coupled to the second input interface 113′ of the last memory module 100d′ of the further multiplicity of memory modules 100a′, 100b′, 100c′, 100d′ in order to transfer data in the second direction, and the second output interface 114′ of the last memory module 100d′ of the further multiplicity of memory modules 100a′, 100b′, 100c′, 100d′ is coupled to the third input interface 27 of the second control unit 20 in order to transfer data in the first direction.

For the remaining memory modules 100b′, 100c′of the further multiplicity of memory modules 100a′, 100b′, 100c′, 100d′, the first input interface 111′ is coupled to the second output interface 114′ of a memory module 100a′, 100b′that is adjacent in the second direction, in order to transfer data in the first direction, the first output interface 112′ is coupled to the second input interface 113′ of the memory module 100a′, 100b′ that is adjacent in the second direction, in order to transfer data in the second direction, the second input interface 113′ is coupled to the first output interface 112′ of the memory module 100c′, 100d′ that is adjacent in the first direction, in order to transfer data in the second direction, and the second output interface 114′ is coupled to the first input interface 111 ‘of the memory module 100c’, 100d′ that is adjacent in the first direction, in order to transfer data in the first direction.

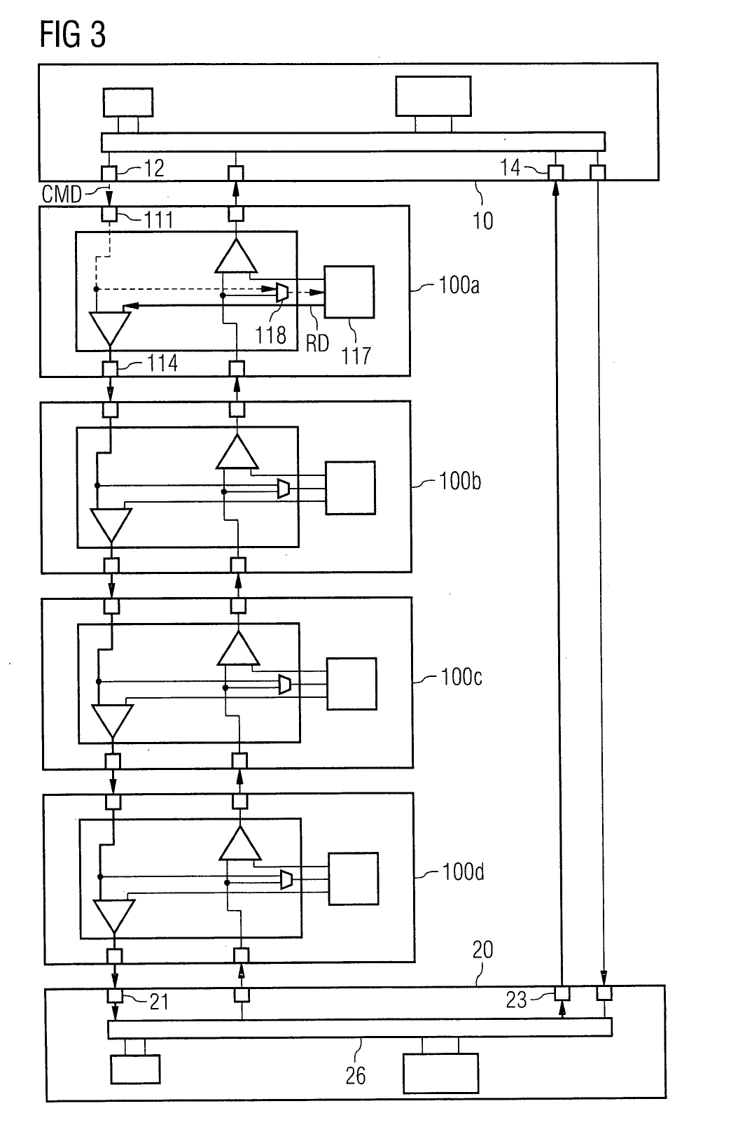

FIG. 3 schematically shows a read operation of a first type in the case of the semiconductor arrangement illustrated in FIG. 1. The first control unit 10 transmits a read command to a memory module in a first direction via the first output interface 12. The read operation for the memory module 100a is indicated here by way of example. The read command is received by the first input interface 111 of the memory module 100a and forwarded via the interface 118 to the memory component 117. The memory component 117 generates read data in a manner dependent on data stored in the memory component 117, which read data are transmitted via the second output interface 114 in the first direction and are transferred by the memory modules 100b, 100c, 100d which are situated in the first direction with respect to the memory module 100a to the first input interface 21 of the second control unit 20. From the first input interface 21 of the second control unit 20, the read data are forwarded via the switch 26 to the second output interface 23 of the second control unit 20 and transferred to the second input interface 14 of the first control unit 10. In FIG. 3, the command data CMD are represented as dashed arrows, and the read data RD are represented as emphasized arrows. In the case of the first type of the read command, the read data RD are inserted into a data frame which is transferred in the same direction from which the data frame with the read command was transferred.

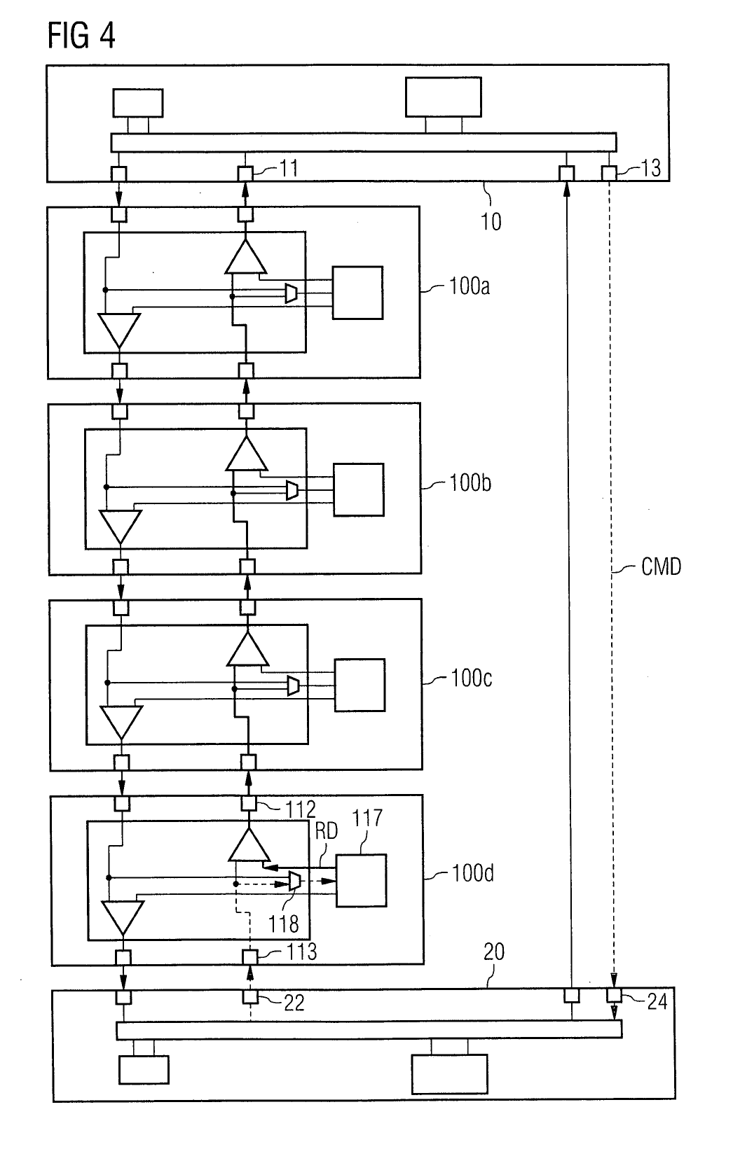

FIG. 4 shows a further read operation of the first type in the case of the semiconductor arrangement illustrated in FIG. 1. The first control unit 10 transmits a read command to a memory module via the second output interface 13 in a second direction, a read command to the memory module 100d being illustrated in FIG. 4. The read command is received by the second input interface 24 of the second control unit 20 and forwarded to the first output interface 22 of the second control unit 20. From there, the read command is transferred to the second input interface 113 of the memory module 100d and forwarded via the interface 118 to the memory component 117. The memory component 117 generates read data RD in a manner dependent on data stored in the memory component 1117. The read data are transmitted via the first output interface 112 in the second direction and are transferred by the memory modules 100c, 100b, 100a which are arranged in the second direction with respect to the memory module 100d to the first input interface 11 of the first control unit 10. In FIG. 4, the command data CMD are represented as dashed arrows, and the read data RD are represented as emphasized arrows.

The read operations illustrated in FIG. 3 and FIG. 4 are indicated as examples of read operations for reading data stored in the memory components of the memory modules. The read command can be transferred from the first control unit 10 both in the first direction and in the second direction to a memory module provided for the read operation. The read data are transmitted by the memory module in the same direction as the one from which the read command was transferred. Each of the memory modules 100a, 100b, 100c, 100d can be read by the first control unit 10 both in the first direction and in the second direction.

The second control unit 20 can likewise read the memory modules by transfer of data both in the first and in the second direction. The read operation is then effected in a manner corresponding to the read operations indicated in FIG. 3 and FIG. 4, the read command being transmitted proceeding from the second control unit 20.

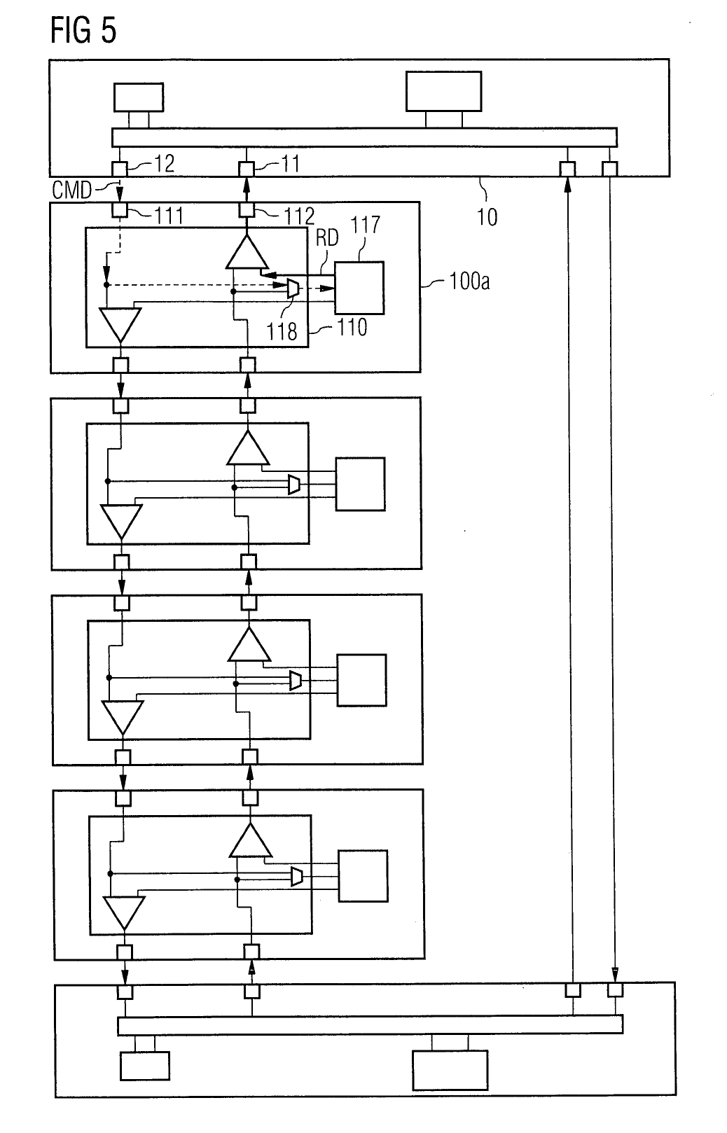

FIG. 5 schematically shows a read operation of a second type in the case of the semiconductor arrangement illustrated in FIG. 1. The first control unit 10 transmits a read command to a memory module via the first output interface 12 in the first direction, a read command to the memory module 100a being illustrated in FIG. 5. The read command is received by the first input interface 111 of the memory module 100a and forwarded via the interface 118 to the memory component 117. The memory component 117 generates read data in a manner dependent on data stored in the memory component 117, the read data are transferred via the first output interface 112 in the second direction to the first input interface 111 of the first control unit. The command data CMD are represented as dashed arrows and the read data RD are represented as emphasized arrows. In the case of the second type of the read command, the read data RD are inserted into a data frame which was received by the memory module 100a from the other direction with respect to the one from which the data frame with the command data was received.

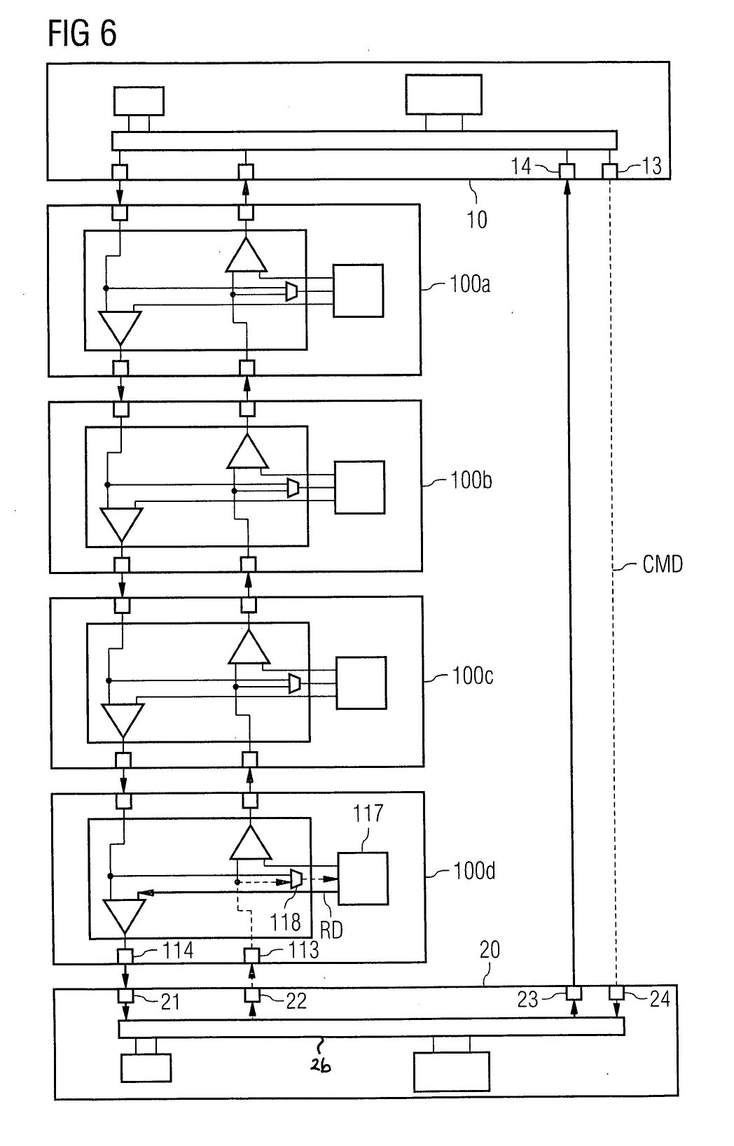

FIG. 6 schematically shows a further read operation of the second type in the case of the semiconductor arrangement illustrated in FIG. 1. The first control unit 10 transmits a read command CMD to a memory module via the second output interface 13 in the second direction, the read command to the memory module 100d being illustrated in FIG. 6. The read command is received by the second input interface 24 of the second control unit 20 and forwarded to the first output interface 22 of the second control unit 20. From there, the read command is transferred to the second input interface 113 of the memory module 100d and forwarded via the interface 118 to the memory component 117. The memory component 117 generates read data RD in a manner dependent on data stored in the memory component 117, which read data are transmitted via the second output interface 114 in the first direction to the first input interface 21 of the second control unit 20. From there, the read data RD are transferred via the switch 26 and via the second output interface 23 of the second control unit 20 to the second input interface 14 of the first control unit.

In the case of the first type of the read operation, the latency for a read operation in the first direction and for a read operation in the second direction is independent of the position of the memory module to be read.

In the case of the second type of the read operation, by contrast, the latency for a read operation is dependent on the position of the memory module to be read.

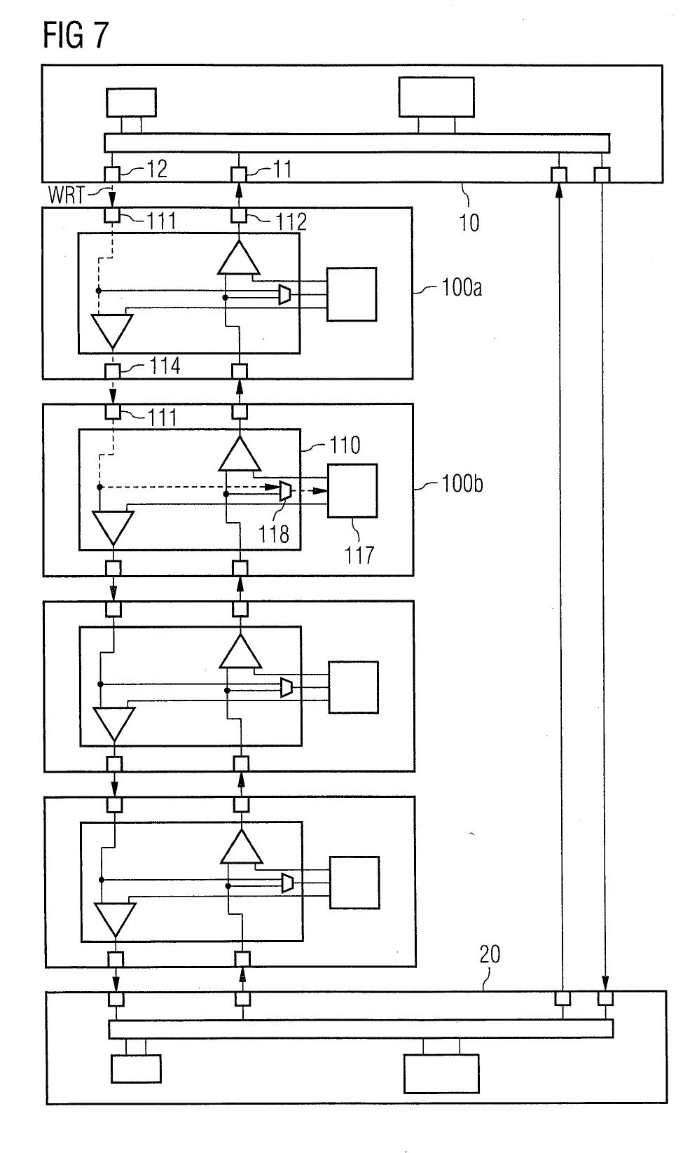

FIG. 7 schematically shows a write operation in the case of the semiconductor arrangement illustrated in FIG. 1. The first memory controller 10 transmits in the first direction, via the first output interface 12, a write command including the write data WRT to be written to the memory module provided for the write operation, the write operation for the memory module 100b being illustrated in FIG. 7. The write command including the write data WRT is received at the first input interface 111 of the memory module 100b. The write data WRT from the received data frame are then forwarded to the memory component 117 and stored therein.

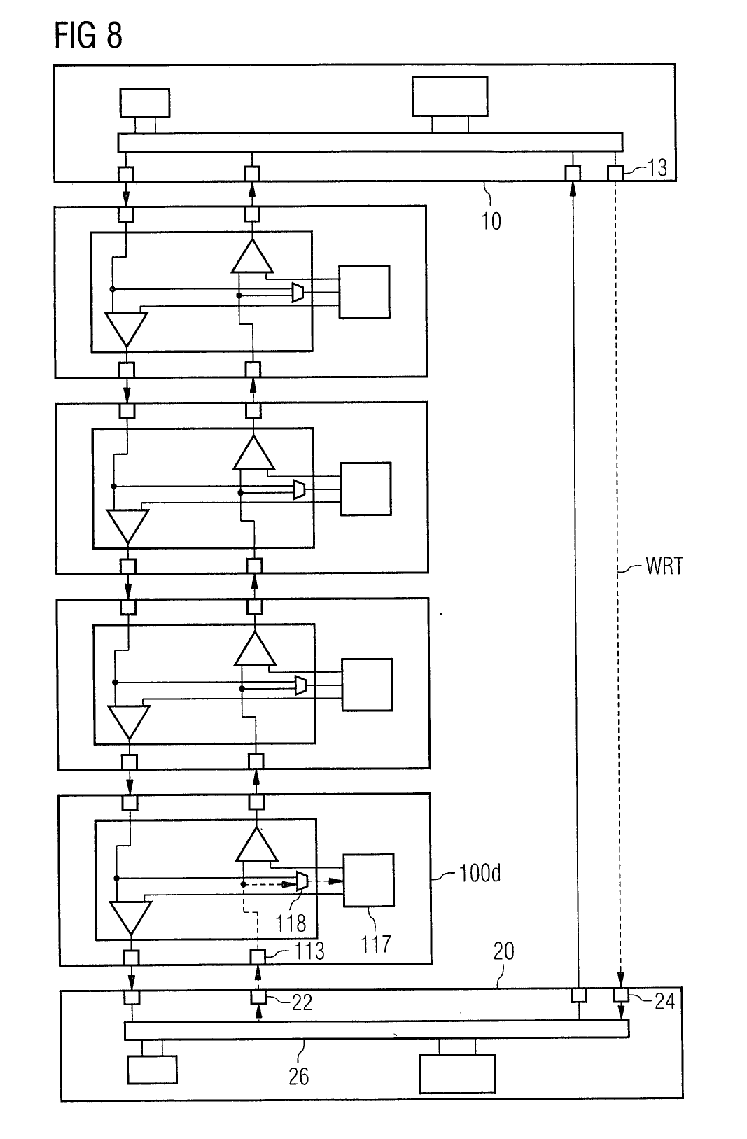

FIG. 8 schematically shows a write operation in the case of the semiconductor arrangement illustrated in FIG. 1. The first control unit 10 transmits in the second direction, via the second output interface 13, a write command including write data WRT to a memory module, the write command to the memory module 100d being illustrated in FIG. 8. The write command including the write data WRT is received by the second input interface 24 of the second control unit 20 and forwarded via the switch 26 and the first output interface 22 of the second control unit 20 to the second input interface 113 of the memory module 100d. From there, the write data WRT from the data frame are forwarded to the memory component 117 and stored therein.

The write operations illustrated in FIG. 7 and FIG. 8 are indicated as examples of write operations for writing data to the respective memory modules. The write command can be transferred from the first control unit 10 both in the first direction and in the second direction to a memory module provided for the write operation.

The second control unit 20 can likewise transmit write commands including write data both in the first and in the second direction to each of the memory modules. The write operation is then effected in a manner corresponding to the write operations indicated in FIG. 7 and FIG. 8, the write command including the write data being transmitted proceeding from the second control unit 20.

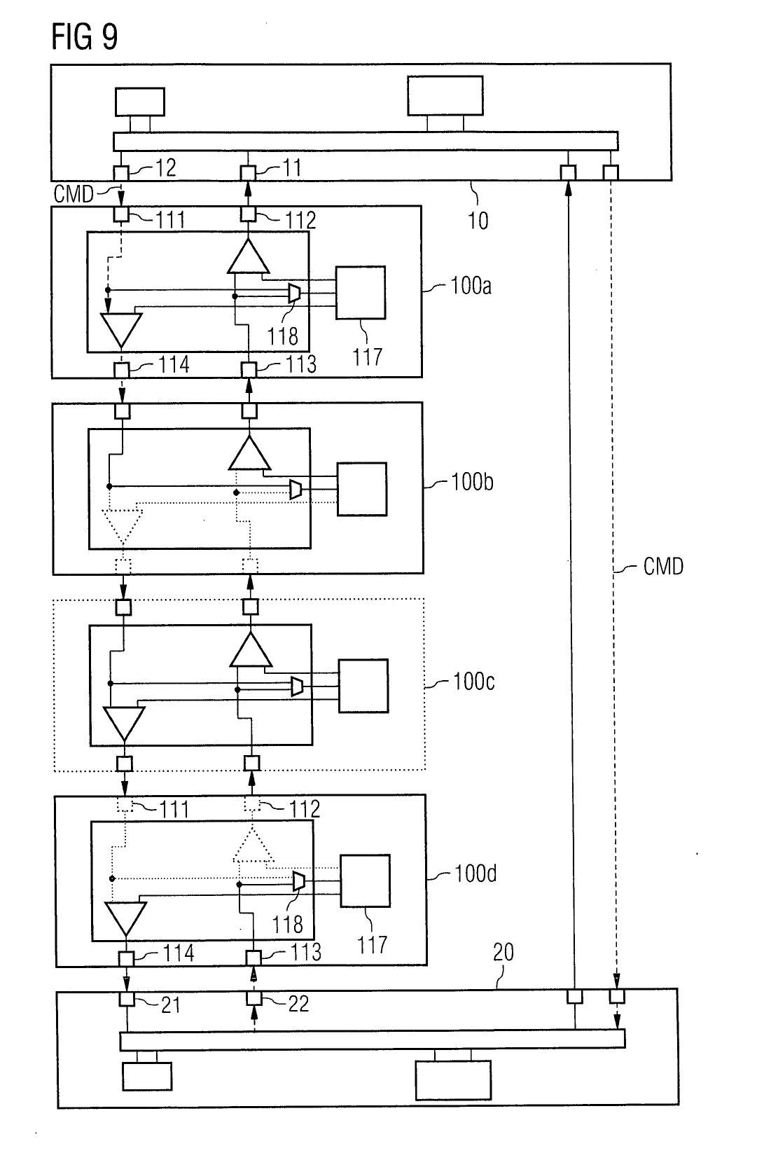

FIG. 9 illustrates the procedure when removing or replacing one of the memory modules (100a, 100b, 100c, 100d). In the present example, the memory module 100c (enclosed by a dotted border) is removed or replaced. The memory module 100c may have a functional disturbance, for example, which is identified by the first control unit 10 or the second control unit 20 or the adjacent memory modules 100b and 100d. In this case, a data transfer from the memory module 100b to the memory module 100d and vice versa, cannot be effected.

By means of a corresponding command that is transmitted from the first control unit in the first direction or from the second control unit in the first direction to the memory module 100b, the memory module 100b is put into an alternative operating mode, in which the input and output interfaces that are adjacent to the memory module 100c to be removed or replaced are deactivated. This deactivation is represented by dotted structures of the memory module 100b in FIG. 9.

The memory module 100d arranged adjacent in the first direction to the memory module 100c that is to be removed or replaced is likewise put into an alternative operating mode by means of a corresponding command transmitted from the first control unit 10 in the second direction or from the second control unit in the second direction. In the alternative operating mode, the input and output interfaces adjacent to the memory module 100c to be removed or replaced are deactivated. This deactivation is represented by dotted structures of the memory module 100d in FIG. 9.

The memory module can now be removed or replaced. In the case where the memory module 100c is removed, the semiconductor arrangement is subdivided into two chain like semiconductor arrangements in which read operations of the second type described with reference to FIGS. 5 and 6 can be performed.

As soon as the memory module to be replaced has been replaced, the first control unit 10 or the second control unit 20 transmits a corresponding command in the second direction to those memory modules which are adjacent to the position of the removed memory module, that is to say to the memory modules 100b and 100d in the case of the example in FIG. 9, in order to reactivate the input and output interfaces which are adjacent to the removed memory module.

What is claimed is:

1. A semiconductor arrangement comprising:
at least one memory module comprising at least one memory component for storing data, a first input interface for receiving data from a first direction, a first output interface for transmitting data in a second direction, a second input interface for receiving data from the second direction, and a second output interface for transmitting data in the first direction;
a first control unit comprising a control circuit, a first input interface, a second input interface, a first output interface and a second output interface, wherein:
the control circuit is coupled to the first input interface in order to receive data from the at least one memory module from the second direction;
the control circuit is coupled to the second input interface in order to receive data from the first direction;
the control circuit is coupled to the first output interface in order to transmit data to the at least one memory module in the first direction; and
the control circuit is coupled to the second output interface in order to transmit data in the second direction;
at least one second control unit comprising a control circuit, a first input interface, a second input interface, a first output interface and a second output interface, wherein:
the control circuit is coupled to the first input interface in order to receive data from the at least one memory module from the first direction;
the control circuit is coupled to the second input interface in order to receive data from the second direction;
the control circuit is coupled to the first output interface in order to transmit data to the at least one memory module in the second direction;
the control circuit is coupled to the second output interface in order to transmit data in the first direction;
wherein the second output interface of the first control unit is coupled to the second input interface of the second control unit; and
wherein the second output interface of the at least one second control unit is coupled to the second input interface of the first control unit.

2. The semiconductor arrangement as claimed in claim 1, wherein the first control unit comprises a switch via which the control circuit of the first control unit is coupled to the first input interface of the first control unit, the second input interface of the first control unit, the first output interface of the first control unit and the second output interface of the first control unit; and
wherein the at least one second control unit comprises a switch, via which the control circuit of the second control unit is coupled to the first input interface of the second control unit, the second input interface of the second control unit, the first output interface of the second control unit and the second output interface of the second control unit.

3. The semiconductor arrangement as claimed in claim 1, wherein the first input interface and the second input interface of the at least one memory module is configured for the transfer of data with an identical data width and the first output interface and the second output interface of the at least one memory module is configured for transfer with an identical data width.

4. The semiconductor arrangement as claimed in claim 1, wherein the second input interface of the first control unit and the second input interface of the second control unit is embodied for the transfer of data with an identical data width, and wherein the second output interface of the first control unit and the second output interface of the second control unit is embodied for the transfer of data with an identical data width.

5. The semiconductor arrangement as claimed in claim 1, wherein the first input interface, the second input interface, the first output interface and the second output interface of the at least one memory module, the second input interface and the second output interface of the first control unit, the second input interface and the second output interface of the second control unit is configured for a frame-based data transfer with an identical frame format.

6. The semiconductor arrangement as claimed in claim 5, wherein the at least one memory module is configured to generate read data upon reception of a read command with the data from the first direction or from the second direction depending on data stored in the memory component, to insert the read data into a received data frame, and to transmit the data frame in the same direction from which it was received.

7. The semiconductor arrangement as claimed in claim 1, wherein a data input of the memory component is connected via an interface both to the first input interface and to the second input interface of the at least one memory module.

8. The semiconductor arrangement as claimed in claim 1, wherein the at least one memory module is configured to generate read data upon reception of a read command with the data either from the first direction or from the second direction depending on data stored in the memory component, wherein the at least one memory module, in the case of a first type of the read command, transmits the read data in the same direction as the one from which the read command was received, and in the case of a second type of the read command, transmits the read data in the other direction with respect to the one from which the read command was received.

9. The semiconductor arrangement as claimed in claim 1, wherein the at least one memory module is configured, upon reception of a corresponding control command, either to deactivate the first input interface and the first output interface or to deactivate the second input interface and the second output interface.

10. The semiconductor arrangement as claimed in claim 1, wherein the semiconductor arrangement comprises a first plurality of memory modules.

11. The semiconductor arrangement as claimed in claim 10, wherein the first output interface of the first control unit is coupled to the first input interface of a first memory module of the first plurality of memory modules in order to transfer data in the first direction;
the first output interface of the first memory module of the first plurality of memory modules is coupled to the first input interface of the first control unit in order to transfer data in the second direction;
the first output interface of the second control unit is coupled to the second input interface of a last memory module of the first plurality of memory modules in order to transfer data in the second direction; and
a second output interface of the last memory module of the first plurality of memory modules is coupled to the first input interface of the second control unit in order to transfer data in the first direction;
wherein for remaining memory modules of the first plurality of memory modules:
the first input interface is coupled to the second output interface of a memory module that is adjacent in the second direction, in order to transfer data in the first direction;
the first output interface is coupled to the second input interface of the memory module that is adjacent in the second direction, in order to transfer data in the second direction;
the second input interface is coupled to the first output interface of a memory module that is adjacent in the first direction, in order to transfer data in the second direction; and
the second output interface is coupled to the first input interface of the memory module that is adjacent in the first direction, in order to transfer data in the first direction.

12. The semiconductor arrangement as claimed in claim 10, wherein the control circuit of the first control unit has read, write and command access to a first subset of the first plurality of memory modules, and in which the control circuit of the second control unit has read, write and command access to a second subset of the first plurality of memory modules, wherein the second subset of the first multiplicity of memory modules is different from the first subset of the first multiplicity of memory modules.

13. The semiconductor arrangement as claimed in claim 10, wherein a memory module of the first plurality of memory modules is embodied as a redundant memory module, in the memory component of which data are stored in a manner dependent on data stored in the memory components of the remaining memory modules of the first plurality of memory modules.

14. The semiconductor arrangement as claimed in claim 10, wherein the semiconductor arrangement comprises a second plurality of memory modules.

15. The semiconductor arrangement as claimed in claim 14, wherein the first control unit comprises a third input interface and a third output interface, and the second control unit comprises a third input interface and a third output interface.

16. The semiconductor arrangement as claimed in claim 15, wherein:
the control circuit of the first control unit is coupled to the third input interface of the first control unit in order to receive data from one of the memory modules of the second plurality of memory modules from the second direction;
the control circuit of the first control unit is coupled to the third output interface in order to transmit data to one of the memory modules of the second plurality of memory modules in the first direction;
the control circuit of the second control unit is coupled to the third input interface of the second control unit in order to receive data from one of the memory modules of the second plurality of memory modules from the first direction; and
the control circuit of the second control unit is coupled to the third output interface in order to transmit data to one of the memory modules of the second plurality of memory modules in the second direction.

17. The semiconductor arrangement as claimed in claim 16, wherein the third output interface of the first control unit is coupled to the first input interface of a first memory module of the second plurality of memory modules in order to transfer data in the first direction;
the first output interface of the first memory module of the second plurality of memory modules is coupled to the third input interface of the first control unit in order to transfer data in the second direction;
the third output interface of the second control unit is coupled to the second input interface of a last memory module of the second plurality of memory modules in order to transfer data in the second direction; and
the second output interface of the last memory module of the second plurality of memory modules is coupled to the third input interface of the second control unit in order to transfer data in the first direction;
wherein for the remaining memory modules of the second plurality of memory modules:
the first input interface is coupled to the second output interface of a memory module that is adjacent in the second direction, in order to transfer data in the first direction;
the first output interface is coupled to the second input interface of the memory module that is adjacent in the second direction, in order to transfer data in the second direction;
the second input interface is coupled to the first output interface of a memory module that is adjacent in the first direction, in order to transfer data in the second direction; and
the second output interface is coupled to the first input interface of the memory module that is adjacent in the first direction, in order to transfer data in the first direction.

18. A method for operating a semiconductor arrangement, wherein the semiconductor arrangement comprises:
at least one memory module comprising at least one memory component for storing data;
a first control unit comprising a control circuit; and
a second control unit comprising a control circuit;
the method comprising:
transmitting data in a first direction from the control circuit of the first control unit to the at least one memory module and receiving data in the control circuit of the first control unit from the at least one memory module from a second direction; and
transmitting data in the second direction from the control circuit of the second control unit to the at least one memory module and receiving data in the control circuit of the second control unit from the at least one memory module from the first direction.

19. The method as claimed in claim 18, the method further comprising:
transmitting data in the second direction from the control circuit of the first control unit to the at least one memory module and receiving data in the control circuit of the first control unit from the at least one memory module from the first direction; and
transmitting data in the first direction from the control circuit of the second control unit to the at least one memory module and receiving data in the control circuit of the second control unit from the at least one memory module from the second direction.

20. The method as claimed in claim 18, the method further comprising:
receiving a read command with the data in the at least one memory module either from the first direction or from the second direction from the control circuit of the first control unit;
generating read data depending on data stored in the memory component;
transmitting the read data from the memory module to the control circuit of the first control unit in the first direction or in the second direction;
receiving a read command with the data in the at least one memory module either from the first direction or from the second direction from the control circuit of the second control unit; and
transmitting the read data from the memory module to the control circuit of the second control unit in the first direction or in the second direction.

21. The method as claimed in claim 20, further comprising:
receiving a write command including write data in the data in the at least one memory module either from the first direction or from the second direction from the control circuit of the first control unit;
storing data in the memory module depending on the received write data in the data;
receiving a write command including write data in the data in the at least one memory module either from the first direction or from the second direction or from the control circuit of the second control unit; and
storing data in the memory module depending on the received write data in the data.

22. The method as claimed in claim 18, wherein the semiconductor arrangement includes a plurality of memory modules n the method further comprising:
removing one of the memory modules of the plurality of memory modules.

23. The method as claimed in claim 22, the method further comprising:
transferring data from a control circuit of a first control unit to a memory module that is situated in the first direction with respect to the removed memory module, in the second direction, and transferring read data from the memory module that is situated in the first direction with respect to the removed memory module to the first control unit in the first direction; and
transferring data from the control circuit of the second control unit to a memory module that is situated in the second direction with respect to the removed memory module, in the first direction, and transferring read data from the memory module that is situated in the first direction with respect to the removed memory module to the second control unit in the first direction.

24. The method as claimed in claim 22, further comprising:
transferring data from the control circuit of the first control unit to a memory module that is situated in the second direction with respect to the removed memory module, in the first direction, and transferring read data from the memory module that is situated in the second direction with respect to the removed memory module to the first control unit in the second direction; and
transferring data from the second control circuit of the second control unit to a memory module that is situated in the first direction with respect to the removed memory module, in the second direction, and transferring read data from the memory module that is situated in the second direction with respect to the removed memory module to the second control unit in the first direction.

25. The method as claimed in claim 18, wherein the semiconductor arrangement includes a plurality of memory modules, the method further comprising:
inserting one of the memory modules during the operation of the semiconductor arrangement.

26. The method as claimed in claim 25, the method further comprising:
transferring data from the control circuit of the first control unit to a memory module that is situated in the first direction with respect to the memory module to be inserted, in the second direction, and transferring read data from the memory module that is situated in the first direction with respect to the memory module to be inserted to the first control unit in the first direction; and
transferring data from the control circuit of the second control unit to a memory module that is situated in the second direction with respect to the memory module to be inserted, in the first direction, and transferring read data from the memory module that is situated in the first direction with respect to the memory module to be inserted to the second control unit in the first direction.

27. The method as claimed in claim 25, further comprising:
transferring data from the control circuit of a first control unit to a memory module that is situated in the second direction with respect to the memory module to be inserted, in the first direction, and transferring read data from the memory module that is situated in the second direction with respect to the memory module to be inserted to the first control unit in the second direction; and
transferring data from the second control circuit of the second control unit to a memory module that is situated in the first direction with respect to the memory module to be inserted, in the second direction, and transferring read data from the memory module that is situated in the second direction with respect to the memory module to be inserted to the second control unit in the first direction.
